(19) United States
(12) Patent Application Publication
(10) Pub. No.: US 2015/0332402 A1
(43) Pub. Date: Nov. 19, 2015

(54) SYSTEM AND METHOD FOR PROVIDING ADDITIONAL INCOME FOR ANNUITIES

(71) Applicant: New York Life Insurance Company, New York, NY (US)

(72) Inventors: Dylan W. Huang, New York, NY (US); Robert C. Blaha, Poughquag, NY (US); Scott Bredikis, Stamford, CT (US); Erik A. Anderson, New York, NY (US)

(21) Appl. No.: 14/447,153

(22) Filed: Jul. 30, 2014

Related U.S. Application Data
(60) Provisional application No. 61/994,495, filed on May 16, 2014.

(51) Int. Cl. G06Q 40/06

(52) U.S. Cl. CPC G06Q 40/06

(57) ABSTRACT

Methods and a system for providing an annuity having income payments and receipt of a dividend. The method comprises receiving a dividend and having the option to receive the dividend in cash, convert it into an income payment stream, defer a portion of the value of the dividend declared to convert into a future dividend stream, or any combination of the foregoing. A portion of a value of dividends from the annuity can be used to purchase additional income payments. Future dividend payments may be based on additional income payments purchased with dividends. The dividend can be used to purchase additional income payments with a first portion of a value of dividends from the annuity and receive a cash payment with a second portion of the value of the dividends from the annuity. The dividend purchased portion of the income payment may be converted to a non-dividend income payment.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The invention described herein generally relates to methods and systems for providing annuities with dividend payment options. More particularly, the methods and systems of the present invention provide a policyholder with options that when elected or exercised allow the policyholder, which may or may not be the annuitant, to receive a cash dividend or to convert some or all of a current payable cash dividend to, e.g., receive a levelized dividend amount or increase income payments.

### BACKGROUND OF THE INVENTION

Annuities are generally contracts that provide individuals with means to accumulate money and/or turn accumulated money into future income payments, for a predefined period of time, computed based on the life expectancy of one or more annuitants. The income payments may be guaranteed for the life or lives of the annuitants and/or for a term certain, such as 5, 10, 15, or 20 years. Annuities are typically purchased from insurance companies that offer a variety of options with regard to the manner in which the income payments are disbursed. Immediate annuities, for example, provide income payments that generally begin immediately or within one year of the contract date. Alternatively, deferred annuities, as the name applies, provide income payments beginning at a later date, such as at the date the policyholder selects as his or her retirement date.

Annuities are often viewed as a prudent investment strategy for many individuals and the availability of dividends associated with annuities may result in cash payments and increased income payments. There is therefore a need for methods and systems for providing annuities with dividend payment options.

### SUMMARY OF THE INVENTION

The present invention provides methods and a corresponding system for providing an annuity having income payments and a dividend payment option. In one embodiment, the method comprises receiving a request to exercise a dividend distribution option associated with an annuity policy, converting, via a processing device, the dividend into additional income payments based on the dividend distribution option, and determining, via the processing device, a total income payment of the annuity policy, wherein the total income payment of the annuity policy would equal the income payment that is generated through distribution of the dividend plus the guaranteed income payments established upon issuance of the annuity policy.

In one aspect of the present invention, the method comprises receiving information useful for issuing an annuity from an individual, and electronically computing, using a processing device, an annuity variable selected from the group consisting of an annuity premium and guaranteed income payments, the annuity variable computed based at least partially on the information obtained from the individual, wherein policyholder may receive the dividend in cash, convert it into an income payment stream, defer a portion of the value of the dividend declared to convert into a future dividend stream, or any combination of the foregoing.

The annuity includes a periodic dividend distribution option where a deferred dividend balance of the dividends from the annuity may be determined. The future dividend stream may include a payable cash dividend based on a present value of future cash dividends from the annuity, the deferred dividend balance, and an annuity factor. According to one embodiment, the payable cash dividend is calculated by dividing the sum of the present value of future cash dividends from the annuity and the deferred dividend balance by an annuity factor. The future dividend stream may be paid in conjunction with the guaranteed income payments.

In another aspect of the present invention, a method comprises receiving information useful for issuing an annuity from an individual, and electronically computing, using a processing device, an annuity variable selected from the group consisting of an annuity premium and guaranteed income payments, the annuity variable computed based at least partially on the information obtained from the individual, wherein the policy holder can purchase additional income payments with a portion of a value of dividends from the annuity. Future dividend payments may be based on additional income payments purchased with dividends. The holder can also use the dividend to purchase additional income payments with a first portion of a value of dividends from the annuity and receive a cash payment with a second portion of the value of the dividends from the annuity.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 illustrates a computing system according to an embodiment of the present invention;

FIG. 2 illustrates a flowchart of a method for providing an annuity with guaranteed income payments including at least one dividend payment option according to an embodiment of the present invention;

FIG. 3 illustrates a flowchart of a method for converting dividends into income payments according to an embodiment of the present invention; and

FIG. 4 illustrates a flowchart of a method for converting levelized dividends conversion into income payments according to an embodiment of the present invention.

### DETAILED DESCRIPTION OF THE INVENTION

Subject matter will now be described more fully hereinafter with reference to the accompanying drawings, which form a part hereof, and which show, by way of illustration, exemplary embodiments in which the invention may be practiced. Subject matter may, however, be embodied in a variety of different forms and, therefore, covered or claimed subject matter is intended to be construed as not being limited to any example embodiments set forth herein; example embodiments are provided merely to be illustrative. It is to be understood that other embodiments may be utilized and structural changes may be made without departing from the scope of the present invention. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

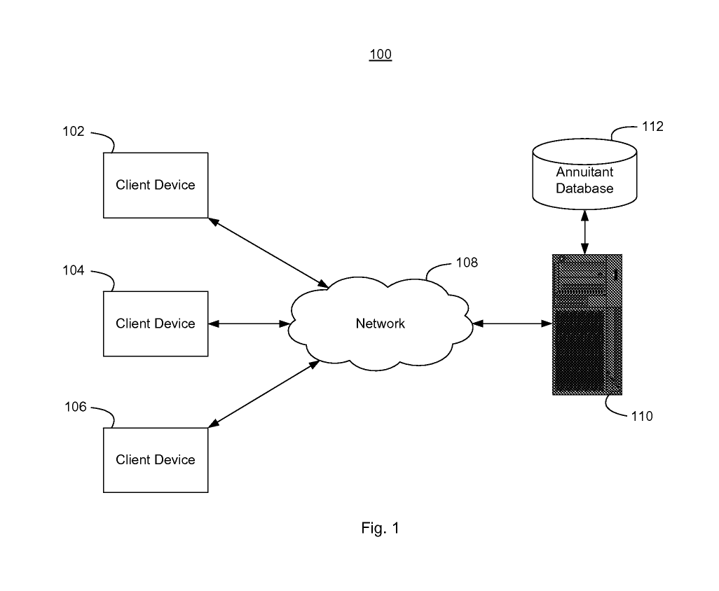

FIG. 1 illustrates a computing system useful in providing an annuity with dividend payment options according to an embodiment of the present invention. System 100 includes client devices 102, 104 and 106, each of which includes at least a processor, memory, a display device, and an input device. The client devices 102, 104, and 106 may comprise general purpose computing devices (e.g., personal computers, mobile devices, terminals, laptops, personal digital assistants (PDA), cell phones, tablet computers, or any computing device having a central processing unit and memory unit capable of connecting to a network) having appropriate software or otherwise designed to compute or assist in computing insurance premiums according to the methods described herein. A client device may also include or execute a variety of operating systems, including a personal computer operating system, such as a Windows, Mac OS or Linux, or a mobile operating system, such as iOS, Android, or Windows Mobile, or the like. A client device may include or may execute a variety of possible applications, such as a client software application enabling communication with other devices. The software may be installed locally at the client devices, thereby enabling a user, such a broker, agent, or potential annuitant, to input information obtained regarding the annuity contract, and to compute or assist in computing a premium for the annuity given a selected or specified future income payments or future income payments given a selected or specified purchase price or premium. The software may be proprietary software designed to provide the methods described herein or, alternatively, commonly available software, such as spreadsheet or database programs, adopted to perform the same. Client devices 102, 104 and 106 may also comprise graphical user interfaces (GUI) or a browser application provided on a display (e.g., monitor screen, LCD or LED display, projector, etc.).

In the embodiment illustrated in FIG. 1, client devices 102, 104 and 106 are communicatively connected to at least one server 110 over a communications network 108. Network 108 may be any suitable type of network allowing transport of data communications across thereof. The network 108 may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. In one embodiment, the network may be the Internet, following known Internet protocols for data communication, or any other communication network, e.g., any local area network (LAN), or wide area network (WAN) connection, wire-line type connections, wireless type connections, or any combination thereof. Communications and content stored and/or transmitted may be encrypted using the Advanced Encryption Standard (AES) with a 256-bit key size, or any other encryption standard known in the art.

Server 110 may include one or more central processing units and memory. The server 110 may also include one or more mass storage devices, one or more power supplies, one or more wired or wireless network interfaces, one or more input/output interfaces, or one or more operating systems, such as Windows Server, Mac OS X, Unix, Linux, FreeBSD, or the like. Server 110 includes at least one database, such as an annuitant database 112. The annuitant database 112 generally includes information useful for issuing and providing an annuity contract, such as personal information, annuity variables, annuity options, etc. In one embodiment, the client devices 102, 104 and 106 may access the relevant database or databases, stored locally at the client devices or remotely at the server 110, for information necessary to compute or otherwise determining the premium or price of the annuity contract or the future income payments, and may update the relevant databases accordingly. Similarly, the client devices 102, 104 and 106 may access the annuitant database to compute income payments, dividend payments, advance payments, and any other annuity-related computations described herein.

The methods and systems according to the present invention may be applied equally to any type of annuity, such as an immediate annuity, a deferred annuity, a fixed rate annuity, a variable annuity, etc. Therefore, although the methods and systems herein will be discussed by way of example in relation to certain types of annuities, it is understood that the present invention is not limited thereto.

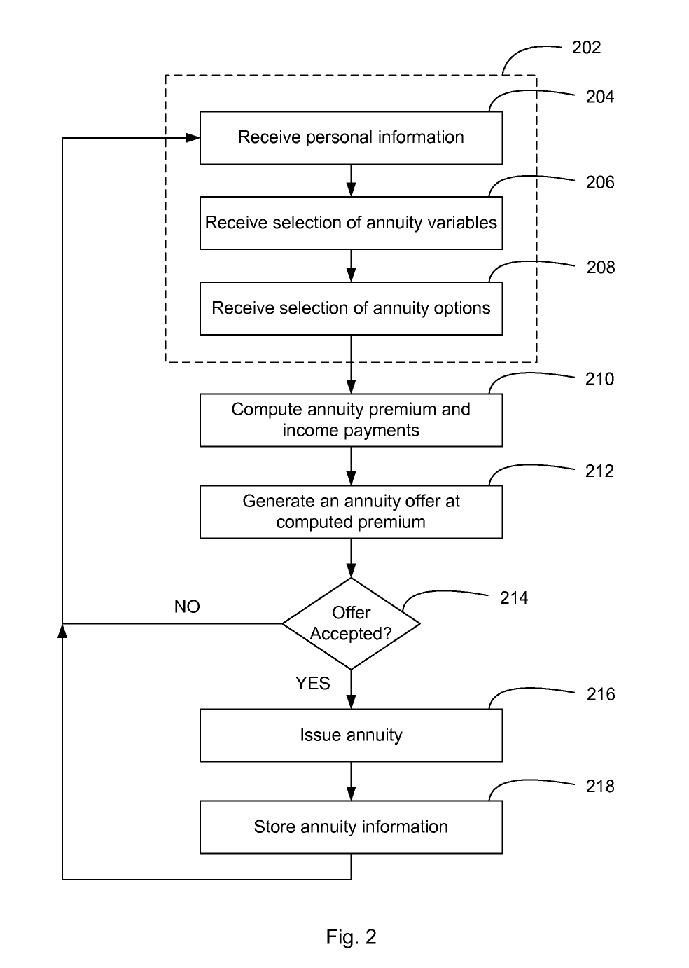

Referring to FIG. 2, a method of providing an annuity having guaranteed income payments with at least one dividend payment option according to an embodiment of the present invention begins at step 202 with obtaining information from an individual or individuals, such as potential annuitants, useful for issuing an annuity contract. The nature of the information that is useful in issuing an annuity contract may vary depending on the type of annuity that is being considered by the individual. Such information may generally be classified as personal information, or information regarding variables associated with the annuity or any available annuity options. Thus, the step of obtaining information may include a plurality of steps including receiving personal information, step 204, receiving a selection of annuity variables, step 206, and receiving a selection of annuity options.

The nature of personal information received in step 204 may vary depending on the type of annuity, and may include information regarding an annuitant's name, age, date of birth, gender, the state or residence, etc. If the annuity includes a co-annuitant or beneficiary, the co-annuitant's and/or beneficiary's personal information may also be obtained. Some personal information may be necessary to compute certain variables associated with annuities, such as to compute the future income payments, the premium or purchase price, etc., and may therefore be required. For example, income payments for an immediate life annuity may be computed based on the annuitant's age and gender.

Annuity variables may be selected or specified by either the potential annuitant or the insurer in step 206. An insurer is used herein to denote the party offering and/or guaranteeing the annuity contract. The insurer may therefore be an insurance company, an underwriter, an employer, a private party, agents thereof, etc. Annuity variables are generally variables that may be used in computing the future income payments or the premium, e.g., the purchase price of the annuity. Annuity variables may therefore differ between different types of annuities. For immediate annuities, for instance, annuity variables may include the premium for the annuity, the desired future income payments, any applicable increases in the periodic payments over time to account for, e.g., inflation, the guarantee period, e.g., life or for a term certain, the applicable interest rate, fees, etc. The insurer will typically specify certain variables, such as the interest rate or rates and any applicable fees. For example, the policyholder may specify or select a premium or purchase price for an immediate annuity of $40,000 that will provide level monthly future income payments for the life of an annuitant at a rate and fees specified by the insurer. Variables for deferred annuities may further include information regarding the date the annuity matures. In the above example, the potential policyholder may further select the maturity date as the date the annuitant reaches the age of 65, which allows policyholders to make periodic payments or contributions that will amount to the total the price of the annuity.

Annuity options may be specified or selected by either the potential purchaser or the insurer in step 208. Annuity options are generally contractual rights conferred under the annuity contract to either party or beneficiary that allows the holder of the right to demand performance or non-performance from one or all of the remaining parties or beneficiaries to the contract. Annuity options, for instance, may be optional features or riders that modify a standard annuity, in which case the policyholder will be able to select from one or more available annuity options. Alternatively, certain annuity options may be standard features of the annuity contract, which will be specified by the insurer. Since annuities are contracts, annuity options may vary in nature and scope limited only by the scope of human ingenuity. A selection of annuity options or riders including annuity options may be used in computing the future income payments or the premium.

With regard to annuity income payments, the income payments may be guaranteed for a period certain and/or for the life of the annuitant. The guaranteed income annuity can generate guaranteed income for an annuitant to meet anticipated future income needs. Information may be received representing at least a current age of the investor, a desired income start date, a desired income payment amount, a premium payment amount, etc., as well as annuity options therein, etc. A desired income start date may be any age that the investor wishes to begin receiving income payments, but not necessarily limited to the age in which the investor actually retires. A policyholder may receive an income start date reminder letter a predetermined number of months prior to their income start date. The policyholder may be given one or more opportunities to elect a different income start date prior to the income start date. If the policyholder changes the income start date, the guaranteed income payments are likely to change.

Generally, an insurance company may invest an annuity policy's premium in various financial instruments such as stocks and bonds or insurance dedicated funds. These financial instruments, which are held in the insurance company's general account or a separate account, may receive dividends, interest and capital gains from these investments. Such increases become part of the insurance company's surplus. The term “dividend” referred to herein may include a distribution to policy owners based on all or preferably a portion, e.g., a percentage, of surplus after paying claims, operating expenses, guaranteed income payments, other liabilities and funding the policy reserves used to provide for future benefits. Guaranteed income annuity policies may also be eligible for dividends. In another embodiment, additional premiums may also be eligible to receive dividends. In one embodiment, a guaranteed income annuity policy may include periodic dividend distributions (e.g., monthly, quarterly, semiannually, or annually). While policies are eligible to receive dividends, dividends, however, are not guaranteed.

Guaranteed income annuities with dividends, according to embodiments of the present invention, provide a predictable income stream during retirement that has the potential to increase through dividends. A unique feature of the present guaranteed income annuity provides guaranteed income payments that can be increased with dividends. According to one embodiment, a guaranteed income annuity may include a plurality of dividend payment options, that when exercised, allow annuity dividends to be paid in cash, employed to purchase additional guaranteed income, deployed in a combination of cash payments and additional guaranteed income, or deferred for a levelized dividend payment option. The dividend payment option may be selected at issue of an annuity contract or at certain times prior to or after the income start date. Dividend payment option(s) can be either part of an annuity policy or purchased as a rider(s) and exercised by the holder of the dividend payment option at the time of a dividend declaration or distribution, or at certain times.

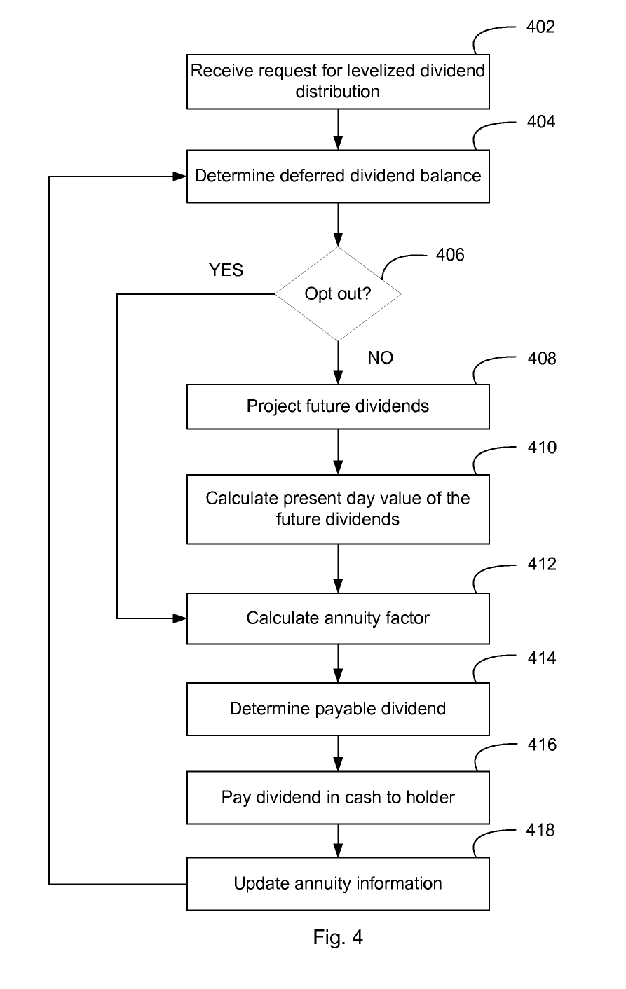

A cash payment of dividends may be credited to the annuity policy in the form of a payment to the annuitant or policyholder, combined with income payments, or accrued to a cash value of the annuity policy to the extent that the annuity policy has a cash value. Alternatively, dividends may be employed to otherwise increase guaranteed lifetime income payments. That is, the guaranteed income payment of the annuity policy may be increased accordingly to reflect a purchase of additional guaranteed income benefits using the dividend. A levelized dividend payment option allows the policyholder of the annuity which may or may not be the annuitant, to defer at least a portion of current payable cash dividends to be converted into a steady future dividend stream. Selection of the levelized dividend payment option automatically defers a dynamically calculated amount of dividend distributions to future dividend payments. Dividend distributions are known to be inconsistent and may be reduced or eliminated all together. The levelized dividend payment option may be offered to individuals who desire to smooth out dividend payments over the annuitant's lifetime, which is described in further detail with respect to the description of FIG. 4.

According to one embodiment, at a pre specified policy anniversary (e.g., 5th, 10th, 15th), the policyholder may elect an income payment conversion option that would convert the dividend related portion of the income payment stream to a non-dividend payment option. If elected, this component of income payments would increase annually and/or be based on the lesser of a fixed rate, consumer price index (CPI), or a benchmark rate such as the 10-year U.S. Treasury less a spread. The election of this option would result in the forfeiture of all future dividends.

In another embodiment, death benefit options may be available to be selected or specified by the potential policyholder or purchaser that provides a distribution to a beneficiary upon the death of the annuitant or annuitants. The policyholder may have the option to purchase a deferral death benefit at contract issue. One option may provide a right of the beneficiary to receive a return of the premium if the annuitant dies before payments begin. However, if the annuitant dies after payments have begun, no further payments are payable. Another option may also provide a right of the beneficiary to receive a return of the premium if the annuitant dies before payments begin and in the event that the annuitant dies after payments have begun but before a period certain is completed, payments will continue to the beneficiary for the period certain. In yet another option may also provide a right of the beneficiary to receive a return of the premium if the annuitant dies before payments begin and in the event that the annuitant dies after payments have begun but before the total income payments equal to the original premium, payments will continue to the beneficiary until payments equal the original premium. According to one embodiment, a death benefit option, available for joint life accounts, may include a right for the beneficiary to receive the present value of the period certain payments if both annuitants die before payments begin.

In one embodiment, income payment options may be available to be selected or specified by the potential policyholder or purchaser of the annuity. A single life only income payment option provides payments for the remainder of an annuitant's life. Under this arrangement, however, payments cease upon the annuitant's death and any money left in the annuity reverts to the insurer. A life with period certain income payment option ensures that even in the event of premature death, beneficiaries would receive payments for a specified number of years (e.g., 5, 10, 15 or 20). A life with cash refund income payment option enables beneficiaries to receive the difference between the premium paid and the sum of payments received by the annuitant from the policy.

A life with installment refund income payment option expands on the cash refund option where beneficiaries can receive payments on a scheduled basis. The installment refund feature provides lifetime income annuitants the ability to provide their beneficiaries with the return of premium, less all payments made, on a scheduled installment basis. For joint life and joint life with period certain policies, an option may be available to reduce income for the surviving annuitant, for example, 40% to 99% of the original income amount after one of the annuitants dies in exchange for a higher income while both are still alive. One or more of the aforementioned income payment options may also be available for single or joint life plans. According to one embodiment, prior to the income start date, the policyholder may be given an opportunity to modify their income payment options. Examples include switching from a single life to joint life or joint life to single life plan, shortening or removing a period certain, or switching from cash refund to period certain.

Certain annuities may include liquidity options in the form of accelerated benefits that allow policyholders to elect to accelerate income payment in order to receive a lump sum benefit in lieu of future payments. A holder of the right to exercise the option may demand from the insurer an advance of future income payments or a portion thereof. However, only guaranteed amounts may be paid (a policyholder may not borrow against future dividends). For example, annuitants may choose to receive a total of six months worth of payments in one lump sum. With regard to the lump sum distribution, a holder of the right may demand a portion of a commuted value of the annuity measured based at least partially on the present value at the time of the conversion of future income payments for the remainder of the guarantee period, such as for the term certain, e.g., 5, 10, 15, etc. years, or for the life expectancies of the annuitants and/or beneficiaries. Thus, the policyholder may demand a lump sum distribution commensurate with the value of the future income payments for the duration of the guarantee period, which may include the lifetime of the annuitant or annuitants. Although the number of times the advanced payment option may be exercised and the magnitude of the advance may be unlimited, an insurer may limit the holder's rights in this respect.

The insurer, for instance, may limit the number of times the option may be exercised, such as once, twice, etc., and may limit the right to exercise the option except at certain times during the term of the annuity, such as at the fifth, tenth, and fifteenth anniversaries of a predefined date, such as the date of the commencement of income payments, or upon a showing of the occurrence of certain predefined events, such as fire, flood, illness, etc. The insured may further limit the magnitude of the advance in terms of a dollar amount, an income period e.g., six months of income, or a plurality of future income payments, e.g., five or six monthly future income payments e.g., six months of income, or a plurality of future income payments, e.g., five or six monthly future income payments, a percentage of the commuted value of the annuity, such as 20%, 30%, 40%, 50%, etc. The insurer may further limit the right to exercise the option until after the annuity payments have begun.

Upon distribution of the payment under this option, future income payments may be adjusted to account for any distribution. A fee or a surcharge may account for the risk associated with this lump sum distribution liquidity option to the insurer, assessed in connection with the lump sum distribution or reflected in the price of the annuity. In one embodiment, after the advance is distributed, subsequent future income payments will not be distributed for a period of time to account for the advance. Thus, for example, an advance of six monthly future income payments may cause the future income payments to cease for the six months for which the advance was taken. Conceptually, the advance may be viewed as a lump sum distribution of six months worth of future income payments in which instance the advance will be of five future income payments and consequently future income payments will cease for a period of five months to account for the distribution. The insurer faces a risk associated with the advance in the event the insured dies before the advance is accounted for, which may be offset with a fee or other measure. In another embodiment, the right to exercise the option is not contingent on collateral circumstances, such as illness, catastrophic events, etc., and may be freely be exercised by the holder subject to any numerical limitations on the number and magnitude of the advance set forth in the annuity.

Additionally, certain annuities may provide liquidity by allowing policyholders to withdraw all or part of an amount of an applicable guaranteed minimum payment duration or total of payments, such as up to the paid premium or a portion thereof. In one embodiment, a withdrawal option may allow a policyholder to withdraw up to 100% of the discounted value of remaining guaranteed payments at any time within the guaranteed period. Once this option is exercised, future income payments through the end of the guaranteed period will be reduced by the withdrawal percentage elected. If the annuitant is alive at the end of the guaranteed period, full annuity payments may then resume for the life of the policy. This feature may be available only on non-qualified policies with a life with cash refund or life with period certain payout option.

In another embodiment, the policyholder may withdraw a given percentage of the discounted value of remaining payments based on life expectancy at policy issuance. The withdrawal option may be exercised at, for example, the 5^{th}, 10^{th}, or 15^{th} anniversary of the first income payment, or at any time upon proof of significant, non-medical financial loss specified in the annuity policy, such as those associated with catastrophic events including fire, flood, earthquake, etc. Once this option is exercised, future income payments will be reduced by the given withdrawal percentage for the life of the policy. This feature may be available on qualified policies, and non-qualified policies such as a life only, life with period certain, or life with cash/installment refund.

A purchaser of the annuity, for example, may give the information, in person, to a broker or an agent acting on behalf of the insurer who will use the information to compute a price for the annuity or compute estimated future income payment amounts based at least partially on the information obtained. Alternatively or in addition, the potential purchaser may relay the information to a remote agent, broker, or insurer with automated means, such as with personal computer or other device capable of communicating the information to the respective party for processing. Potential purchasers, for example, may communicate the relevant information via email or other forms of text messaging, or via an insurers World Wide Web site which will provide an interface for potential policyholders to communicate specific information to the insurer.

After the information is obtained from the potential purchaser and/or procured by the insurer, a premium for an annuity of a specified or desired future income payment, or the future income payments for a specified or desired premium, may then be computed based at least partially on the information obtained, step 210. Premiums for annuities including optional features (e.g., options and benefits) or riders including the optional features may also pay for costs and/or fees associated with the optional features. Additionally, for a deferred annuity, the periodic contribution necessary towards the total premium may also be computed. The premium or the future income payments may be computed using standard equations and/or actuarial data known in the art with regard to annuities. The computation may be performed with a variety of manual and/or automated means. An annuity offer at the computed premium is generated, step 212. The computed premium and/or the future income payments may be presented to a prospective client in the form of an offer to purchase the annuity.

If at step 214 the individual does not accept the offer to purchase the annuity, the information obtained may be either saved, such as on a computer system described in FIG. 1, for future reference, or discarded. The methods described above can be repeated for the next potential purchaser. If the individual to whom the offer was made accepts the offer, the annuity will issue at the computed or specified premium or purchase price, step 216. The steps required to issue an annuity vary depending on the nature of the individual that obtained the information. For example, where the insurer or a party authorized to act on behalf of the insurer obtained the information, the annuity will issue automatically or at some predetermined time thereafter, e.g., 30 days, etc. If however, the individual is an insurance agent with limited authority to bind the insurer, the annuity may issue only after first being reviewed and accepted by the insurer. Similarly, conditions can be imposed by the insurer, such as a physical, etc., that must be satisfied before the annuity issues. In any event, if the annuity issues, the information obtained, such as the personal information, annuity variables, and annuity options, and any other relevant information are stored in an appropriate database, step 218, such as an annuitant database.

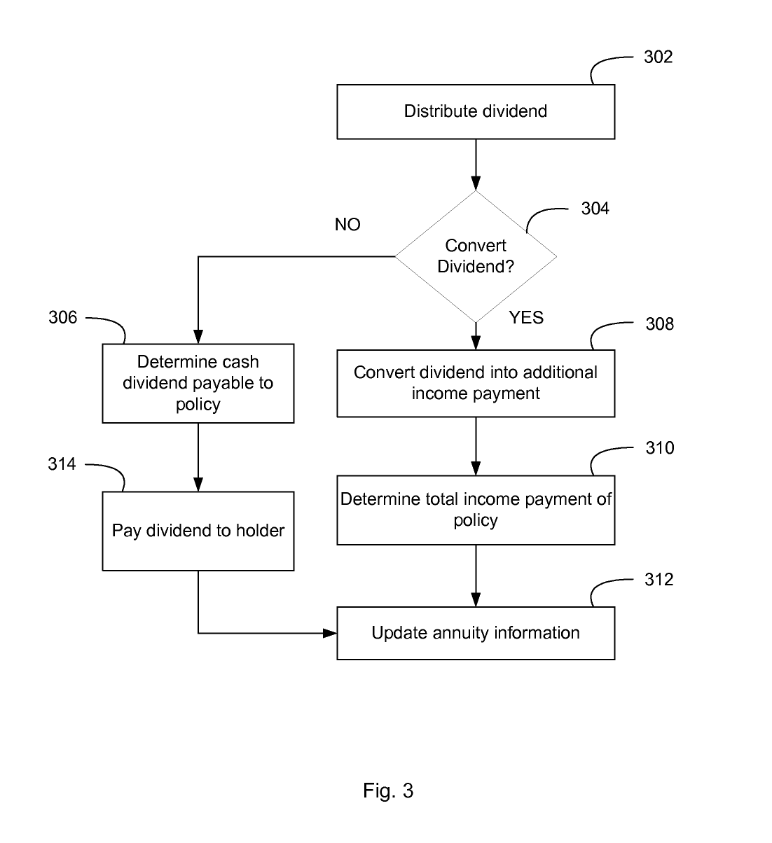

Referring to FIG. 3, a method for converting dividends into income payments according to one embodiment begins with a dividend distribution, step 302. In one embodiment, a dividend associated with an annuity policy may be offered for distribution to the annuitant periodically or as determined by the annuity provider. The annuity policy may include one or more dividend payment options which the annuitant or policyholder may exercise. Dividend payment options described elsewhere in the present application may be exercised by the annuitant or policy holder of the options at the time of the dividend distribution, or at any other predefined time. The annuitant or policyholder of the annuity policy is therewith able to convert the offered dividends into income payments by exercising a dividend distribution option included in the annuity policy. If the annuitant or policyholder does not choose to exercise the dividend conversion option to convert the dividend into another form of payment (in step 304), a dividend payable to the annuity policy is determined in step 306. Thereafter, step 314 includes paying the determined dividend to the holder of the annuity policy.

However, if a request to convert the dividend into an additional income payment is received from the annuitant or policyholder (in step 304), the dividend is converted into additional income payment, step 308. The dividend is converted into additional income payment(s) based on the dividend distribution option. For example, converting the dividend into an addition income payment according to the dividend distribution option allows for purchase of additional income using the dividend amount. In addition, future dividend payments may be based on the additional income payments purchased with dividends. A total income payment of the annuity policy is determined, step 310. Determining the total income payment of the annuity policy includes adding the additional income converted from the dividend to any existing income payments of the annuity policy. The annuity information is updated, step 312, to reflect the additional income payment.

Referring to FIG. 4, an optional method of levelized dividend distribution into income payments begins, in an alternative embodiment, at step 402 with receiving a request to exercise a levelized dividend distribution option of an annuity contract. The request may be received from an election of the policyholder at issue of the annuity contract or at certain times prior to or after an income start date. The levelized dividend payment option may be elected to defer and convert current payable dividends into a steady dividend stream over the annuitant's life. The following steps may be performed for the entirety of an annuity policy upon exercising the levelized dividend payment option. A deferred dividend balance is determined, step 404. At least a portion of dividends the policyholder may have deferred from a prior period (e.g., month, quarter, or year) under the policy provides a steady future dividend stream. The prior period deferred dividend balance may be accumulated with guaranteed mortality credits and guaranteed interest rate credits. Prior to the first dividend payment, the deferred dividend balance may be a total of dividend distributions expected to be received in the annuity policy. Accordingly, the deferred dividend balance is subsequently increased or reduced based on future dividend distributions and dividend payments.

A determination is made whether the policyholder has opted out of the levelized dividend payment option, step 406. If after electing the levelized dividend payment option for a period of time, the policyholder may choose not to elect the levelized dividend payment option. In such as case, the present method may proceed to step 412. If the policyholder has not opted out of the levelized dividend payment option, the method proceeds to project future dividends, step 408. In step 408, all or at least a portion of future dividends may be projected based on current dividend interest rate and dividend mortality expense. Upon projection of the future dividends, a present value of the future dividends is calculated, step 410. The present value of the future dividends represents a present day value of dividends received at a future date. The future date may be based on the life expectancy of the annuitant or the end of a period certain. The present value of the future dividends may be calculated using guaranteed mortality expense and guaranteed interest rate.

An annuity factor is calculated, step 412. The annuity factor is calculated to represent the present value of an annuity's income stream each period for a specified number of periods. The annuity factor may be calculated using the guaranteed mortality expense and guaranteed interest rate. In a next step 414, a payable dividend is determined. In one embodiment, the payable dividend is calculated by the following:

$$\frac{( PVDiv + DefDivBal )}{AnnFactx} ,$$

where PVDiv is the present value of future dividends, DefDivBal is the deferred dividend balance, and AnnFactx is the annuity factor. The payable dividend may be calculated periodically (e.g., to account for additional deferrals of dividend distributions) creating a levelized stream of dividend payments. As such, a remainder of dividend distributions (the deferred dividend balance) after payment of the payable dividend is deferred into a future stream of dividend payments. Cash payments of the payable cash dividend may be paid to the annuitant or policyholder (step 416) periodically as specified in the annuity contract or in conjunction with income payments.

According to this embodiment, the levelized dividend is capped at the payable cash dividend plus the deferred dividend balance. The policyholder may not be permitted to borrow against future dividends. The policyholder also may not withdraw their deferred dividend balance and deferred dividend balances may not be payable upon death. The payment of the payable cash dividend may be made in a variety of ways as well, such as in the form of a cash value, which includes actual cash, payment by check, wire transfer, etc. The annuity information may then be updated, step 418, to reflect and/or account for the payable cash dividend. The above steps 404 through 418 may be repeated for subsequent annuity periods to convert at least a portion of dividends deferred in the subsequent annuity periods into future dividends.

FIGS. 1 through 4 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

What is claimed is:

1. A method for providing an annuity having income payments and receipt of a dividend, the method comprising:
receiving a request to exercise a dividend distribution option associated with an annuity policy;
converting, via a processing device, the dividend into additional income payment in response to the exercise of the dividend distribution option; and
determining, via the processing device, a total income payment of the annuity policy, wherein determining the total income payment of the annuity policy includes increasing the income payments of the annuity policy by the additional income payment.

2. The method of claim 1 further comprising determining a deferred dividend balance of the dividends from the annuity.

3. The method of claim 1 wherein the dividend is payable in the form of cash payments.

4. A method for providing an annuity having guaranteed income payments and receipt of a dividend comprising:
receiving information useful for issuing an annuity from an individual; and
electronically computing, using a processing device, an annuity variable selected from the group consisting of an annuity premium and guaranteed income payments, the annuity variable computed based at least partially on the information obtained from the individual, wherein the holder of the annuity converts therewith at least a portion of a value of dividends from the annuity into a future levelized dividend stream.

5. The method of claim 4 wherein the future levelized dividend stream includes a payable cash dividend based on a present value of future cash dividends from the annuity, the deferred dividend balance, and an annuity factor.

6. The method of claim 5 wherein the payable cash dividend is calculated by the following: (PVDiv+DefDivBal)/AnnFactx, where PVDiv is the present value of future cash dividends from the annuity, DefDivBal is the deferred dividend balance, and AnnFactx is the annuity factor.

7. The method of claim 4 wherein the future levelized dividend stream is paid in conjunction with the guaranteed income payments.

8. The method of claim 4 wherein the annuity includes a periodic dividend distribution.

9. A method for providing an annuity having guaranteed income payments and receipt of a dividend comprising:
receiving information useful for issuing an annuity from an individual; and
electronically computing, using a processing device, an annuity variable selected from the group consisting of an annuity premium and guaranteed income payments, the annuity variable computed based at least partially on the information obtained from the individual, wherein a dividend payment option allows a holder of the annuity to exercise the dividend payment option and purchase additional income with all or a portion of a value of dividends from the annuity.

10. The method of claim 9 wherein the additional income payments are eligible to receive dividends.

11. The method of claim 9 wherein the holder of the annuity has the option to purchase additional income payments with a first portion of a value of dividends from the annuity and receive a cash payment with a second portion of the value of the dividends from the annuity.

12. The method of claim 9 wherein the holder of the annuity has the option to convert the dividend purchased portion of the income payment to a non-dividend income payment.

13. The method of claim 12 wherein the non-dividend income payment is increased based on at least one of a fixed rate, consumer price index, or a benchmark rate based on a 10-year U.S. treasury rate less a spread.
